(19) United States
(12) Patent Application Publication
(10) Pub. No.: US 2012/0112898 A1
(43) Pub. Date: May 10, 2012

(54) PROGRAMMABLE TIRE-CONDITION SENSOR HAVING A FLEXIBLE SHELL, ITS INSTALLATION METHOD AND A TIRE CARRYING SAME

(76) Inventors: San-Chuan YU, Changhua County (TW); Chih-Ming Chiang, Kaohsiung CIty (TW); Yuan-Tung Hung, Changhua County (TW); Tsan-Nung Wang, Changhua County (TW)

(21) Appl. No.: 12/940,520

(22) Filed: Nov. 5, 2010

(51) Int. Cl. B60C 23/02

(52) U.S. Cl. 340/442

(57) ABSTRACT

A programmable tire-condition sensor includes a control module, which includes a circuit board carrying a battery, a power switch, a processor, a memory, a pressure sensor, a temperature sensor, an acceleration sensor, a voltage sensor, a transmission interface unit and a connection port, and a flexible shell that has a surface area greater than the circuit board, an uplifted area on the middle, an opening, a switch accommodation hole for accommodating the power switch and a connection port accommodation hole for accommodating the connection port. A vehicle tire is also disclosed having installed therein the programmable tire-condition sensor, and a method is still also disclosed for installing the programmable tire-condition sensor in a vehicle tire.

### BACKGROUND OF THE INVENTION

1. Field of the Invention

The present invention relates to tire pressure measuring technology and more particularly, to a programmable tire-condition sensor having a flexible shell. The invention relates also to the installation method of the programmable tire-condition sensor and a vehicle tire carrying the programmable tire-condition sensor.

2. Description of the Related Art

Currently, for measuring the internal temperature and pressure of vehicle tires to assure driving safety, most vehicle tires are equipped with a vehicle tire-condition sensor. U.S. Pat. No. 5,218,861 discloses tire-condition sensor design, entitled “Pneumatic tire having an integrated circuit transponder and pressure transducer”. According to this design, the integrated circuit transponder and pressure transducer is embedded in the rubber of the vehicle tire, not detachable for maintenance. Further, the installation location of the integrated circuit transponder and pressure transducer is far from the axis of the vehicle tire where the centrifugal force is maximized. However, this location is the most unstable place where the deformation amount is maximized. Further, this place tends to be pierced by a pointed external object. A sensor installed in this location tends to be damaged. Further, if the vehicle tire is to be reclaimed, the embedded integrated circuit transponder and pressure transducer complicates tire reclamation.

Further, U.S. Pat. No. 6,673,611 discloses a monitoring device for monitoring conditions of vehicle tires, entitled “Method of monitoring conditions of vehicle tires and tires containing a monitoring device therein”. According to this design, the monitoring device is packaged in a packaging material and then installed in a vehicle tire. Thus, this design does not allow repair or replacement of battery. Further, because the vehicle tire will deform subject to the condition of the road during running, it is better to maximize the deformable area of the monitoring device, or to allow deformation of the monitoring device with the vehicle tire. On the contrary, this design has the monitoring device be packaged in a packaging material that is not highly deformable. Thus, the chance of damage of the monitoring device is greatly increased during deformation of the vehicle tire.

Further, another prior art discloses an attachable tire-condition monitoring device. According to this design, the attachable tire-condition monitoring device is to be attached to the wheel rim that is usually made of a ferro-alloy or aluminum alloy and tends to interfere with or isolate the transmission of LF (low frequency) or RF (radio frequency) signals. Further, it is not easy to bond the attachable tire-condition monitoring device to a metal surface, and the attachable tire-condition monitoring device may fall from the metal surface easily upon a heavy vibration force.

### SUMMARY OF THE INVENTION

The present invention has been accomplished under the circumstances in view. It is the main object of the present invention to provide a programmable tire-condition sensor having a flexible shell, which has a simple structure and facilitates installation and maintenance.

To achieve this and other objects of the present invention, a programmable tire-condition sensor comprises a control module and a flexible shell. The control module comprises a circuit board, a battery set arranged on the circuit board to provide the necessary working power, a power switch adapted for switching on/off the battery set, a processor, a memory electrically connected to the processor and repeatedly readable and writable, a pressure sensor installed in the circuit board and electrically connected to the processor and adapted for sensing the internal pressure of the vehicle tire, a temperature sensor electrically connected to the processor and adapted for sensing the internal temperature of the vehicle tire, an acceleration sensor electrically connected to the processor and adapted for sensing the acceleration value of the vehicle tire, a voltage sensor adapted for sensing the voltage of the battery set, transmission interface means electrically connected to the processor and adapted for transmitting the data sensed by the pressure sensor, the temperature sensor and the acceleration sensor to a vehicle receiving device, and a connection port for enabling the circuit board to be electrically connected by an external transmission line to an external setting apparatus. The flexible shell has a surface area greater than the circuit board and is adapted for bonding to the vehicle tire to hold the control module on the vehicle tire. Further, the flexible shell comprises an uplifted area on the middle, an opening, a switch accommodation hole for accommodating the power switch and a connection port accommodation hole for accommodating the connection port.

The invention also provides a vehicle tire having installed therein the programmable tire-condition sensor.

The invention further provides a method for installing the programmable tire-condition sensor in a vehicle tire.

### BRIEF DESCRIPTION OF THE DRAWINGS

FIG. 1 is a schematic drawing illustrating a programmable tire-condition sensor installed in a vehicle tire in accordance with a first embodiment of the present invention.

FIG. 2 is an enlarged view of a part of FIG. 1.

FIG. 3 is a schematic sectional view of the programmable tire-condition sensor in accordance with the first embodiment of the present invention.

FIG. 4 is a top view of FIG. 3.

FIG. 5 is an elevational view of the programmable tire-condition sensor in accordance with the first embodiment of the present invention.

FIG. 6 is a schematic drawing illustrating a programmable tire-condition sensor installed in a vehicle tire in accordance with a second embodiment of the present invention.

FIG. 7 a schematic sectional view of the programmable tire-condition sensor in accordance with the second embodiment of the present invention

FIG. 8 is an elevational view of the programmable tire-condition sensor in accordance with the second embodiment of the present invention.

### DETAILED DESCRIPTION OF THE INVENTION

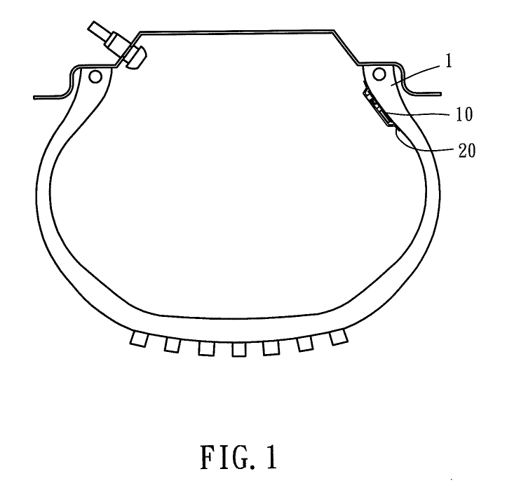

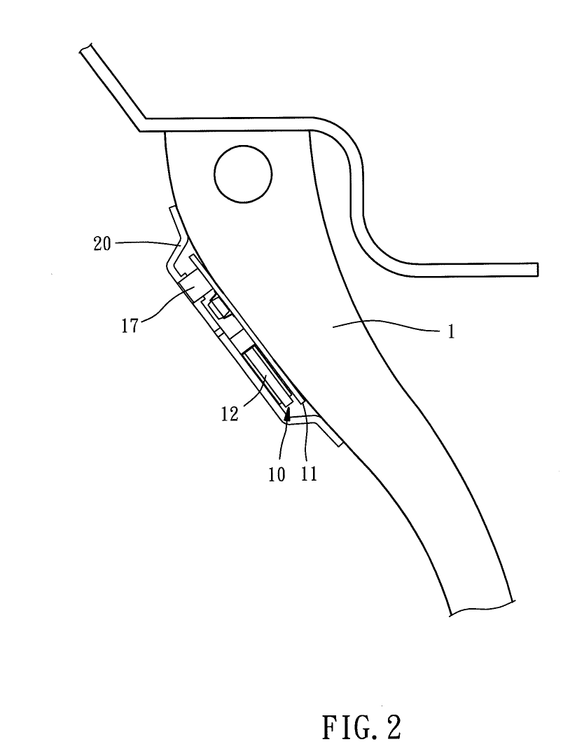

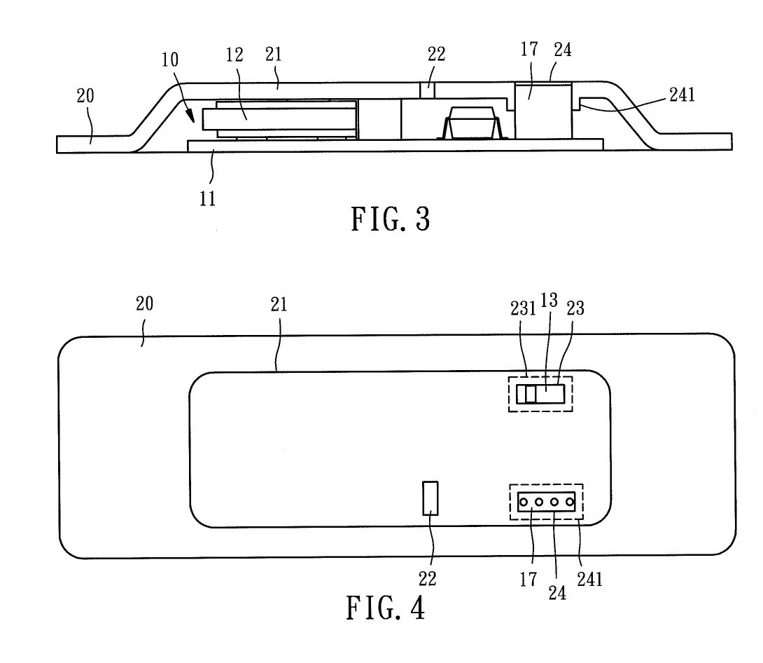

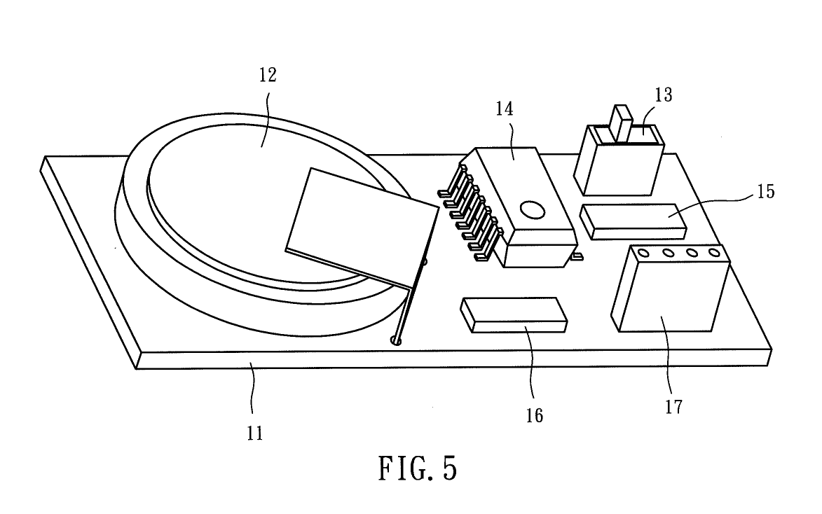

Referring to FIGS. 1-5, a programmable tire-condition sensor in accordance with a first embodiment of the present invention is shown installed in a vehicle tire.

The programmable tire-condition sensor comprises a control module 10 and a flexible shell 20.

The control module 10 comprises: a circuit board 11, a battery set 12 arranged at the top side of the circuit board 11 to provide the necessary working power, a power switch 13 adapted for switching on/off the power of the battery set 12, a processor (not shown), a memory (not shown) electrically connected to the processor and repeatedly readable and writable, a pressure sensor 14 installed in the circuit board 11 and electrically connected to the processor and adapted for sensing the internal pressure of the vehicle tire, a temperature sensor 15 electrically connected to the processor and adapted for sensing the internal temperature of the vehicle tire, an acceleration sensor 16 electrically connected to the processor and adapted for sensing the acceleration value of the vehicle tire, a voltage sensor (not shown) adapted for sensing the voltage of the battery set, a transmission interface unit comprising a LF (low frequency) transmission interface and a RF (radio frequency) transmitting interface (not shown) and electrically connected to the processor and adapted for transmitting the data sensed by the pressure sensor 14, temperature sensor 15 and acceleration sensor 16 to the on-vehicle main unit by LF (low frequency) or RF (radio frequency), and a connection port 17 for enabling the circuit board 11 to be electrically connected by an electrical plug of an external transmission line.

The flexible shell 20 is made of natural rubber or synthetic rubber. Because the material of the flexible shell 20 is similar to regular vehicle tires, the flexible shell 20 can easily and positively be bonded to the inside wall of a vehicle tire. The surface area of the flexible shell 20 is greater than the circuit board 11. Further, the flexible shell 20 has an uplifted area 21. The elevation difference between the bottom surface of the uplifted area 21 and the bottom surface of the periphery of the flexible shell 20 is smaller than the height of the control module 10. Further, the flexible shell 20 defines an opening 22, a switch accommodation hole 23 for accommodating the power switch 13, and a connection port accommodation hole 24 for accommodating the connection port 17. The flexible shell 20 further comprises two annular inside flanges 231 and 241 protruded from the bottom wall thereof and respectively extending around the switch accommodation hole 23 and the connection port accommodation hole 24 for sleeving onto the power switch 13 and the connection port 17 respectively.

When using the programmable tire-condition sensor, the programmable tire-condition sensor is installed subject to the following steps: covering the flexible shell 20 onto the control module 10 to have the power switch 13 be accommodated in the switch accommodation hole 23 and the connection port 17 be accommodated in the connection port accommodation hole 24, and then applying a glue to the peripheral edge of the flexible shell 20 and bonding the flexible shell to the inner side of the bead filler of the vehicle tire 1 by thermo-compression bonding. This installation location is the best location where the vehicle tire deformation amount is minimized. Preferably, the flexible shell 20 is positioned opposite to the vehicle tire valve so that the programmable tire-condition sensor is kept relatively closer to the body of the vehicle, assuring high installation stability and high signal transmission quality. As the height of the uplifted area 21 is smaller than the height of the control module 10, the control module 10 is firmly secured in place between the flexible shell 20 and the vehicle tire 1 with little spare space left after bonding of the flexible shell 20 to the vehicle tire 1, avoiding control module vibration.

After bonding of the flexible shell 20 to the vehicle tire 1, a transmission line is installed to electrically connect the control module 10 to an external setting apparatus, and then loading the selected transmission programs and encoding programs into the memory of the control module 10. After program loading, remove the transmission line and then switch on the power switch to start up the programmable tire-condition sensor for functioning.

The advantage of the present invention is the use of the flexible shell to maximize the deformable area of the programmable tire-condition sensor, lowering the chance of sensor damage. Further, because the memory of the control module 10 is repeatedly readable and writable, the user can connect a transmission line to the connection port and then regulate the related settings when the position of the vehicle tire is changed, for example, inter-exchange of front and rear tires. When the vehicle tire wears out and is to be discarded, cut off the flexible shell 20 and then remove the control module 10 from the vehicle tire. Thus, the flexible shell 20 and the vehicle tire can be reclaimed without any trouble.

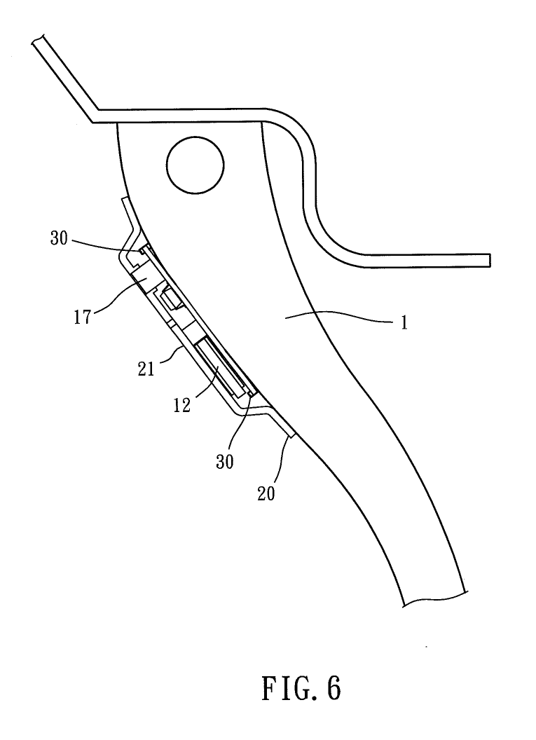

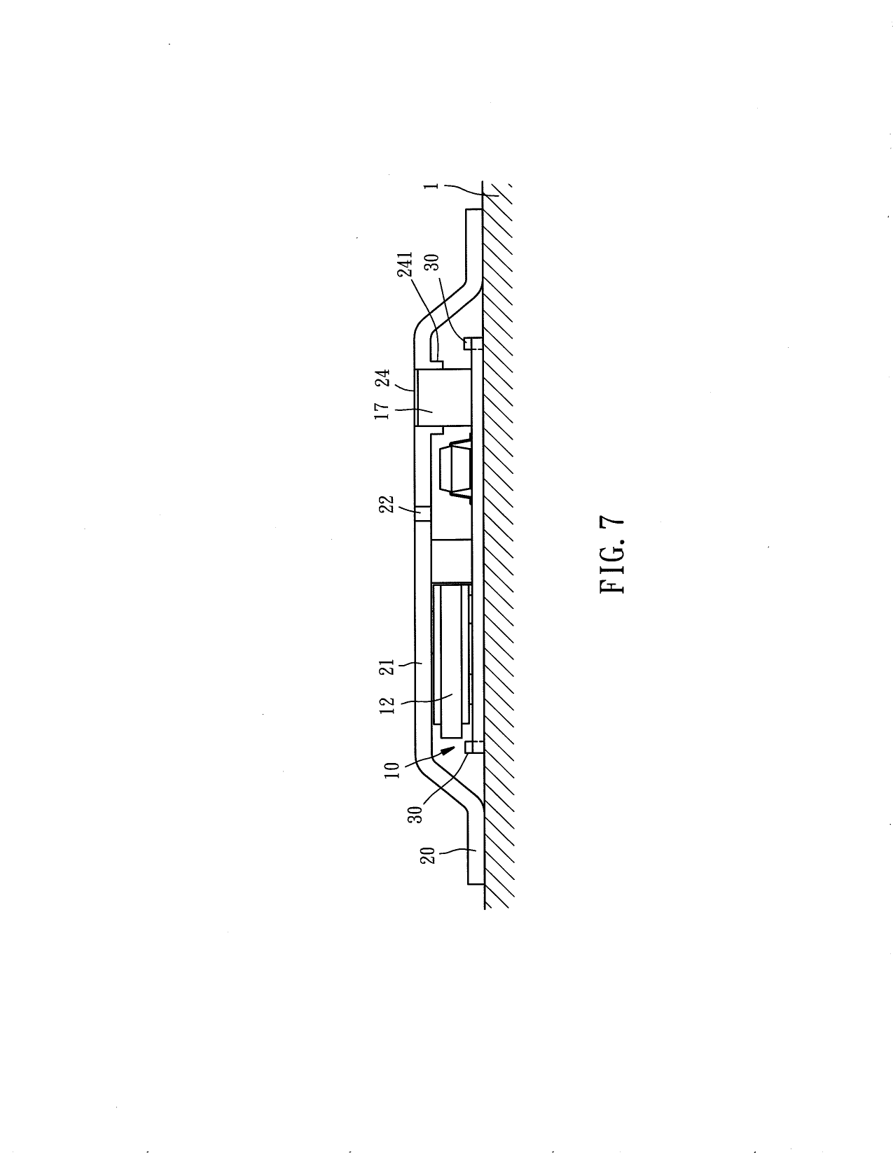

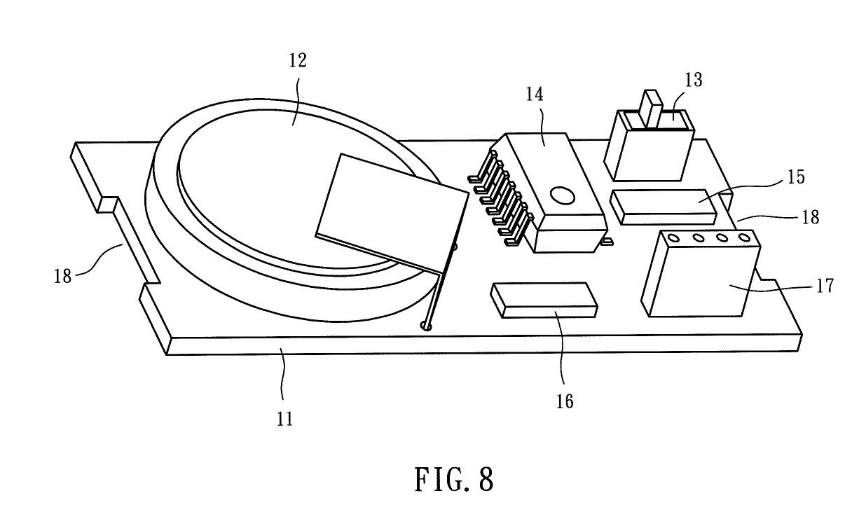

FIGS. 6-8 illustrate a programmable tire-condition sensor in accordance with a second embodiment of the present invention. According to this second embodiment, the programmable tire-condition sensor comprises a control module 10 and a flexible shell 20. The flexible shell 20 is same as that of the aforesaid first embodiment. The main feature of this second embodiment is as follows:

The circuit board 11 of the control module 10 in accordance with this second embodiment has two mounting notches 18 respectively disposed at the two distal ends thereof. Further, the vehicle tire 1 comprises two protruding blocks 30 disposed at the inner side of the bead filler thereof corresponding to the mounting notches 18 of the circuit board 11. The distance between the two protruding blocks 30 can be equal to or slightly shorter than the distance between the two mounting notches 18. When installing the control module 10 in the vehicle tire 1, the control module 10 can be clamped between the two protruding blocks 30, enhancing installation accuracy and stability. After bonding of the flexile shell 20 to the vehicle tire 1, the control module 10 is kept positively and firmly in position.

Thus, the invention also provides a vehicle tire having a programmable tire-condition sensor with a flexible shell installed therein, wherein the programmable tire-condition sensor is installed in the inner side of the bead filler of the vehicle tire.

What is claimed is:

1. A programmable tire-condition sensor for installation in a vehicle tire, comprising:
a control module, said control module comprising a circuit board, a battery set arranged on said circuit board to provide the necessary working power, a power switch adapted for switching on/off said battery set, a processor, a memory electrically connected to said processor and repeatedly readable and writable, a pressure sensor installed in said circuit board and electrically connected to said processor and adapted for sensing the internal pressure of the vehicle tire, a temperature sensor electrically connected to said processor and adapted for sensing the internal temperature of the vehicle tire, an acceleration sensor electrically connected to said processor and adapted for sensing the acceleration value of the vehicle tire, a voltage sensor adapted for sensing the voltage of the battery set, transmission interface means electrically connected to said processor and adapted for transmitting the data sensed by said pressure sensor, said temperature sensor and said acceleration sensor to a vehicle receiving device, and a connection port for enabling said circuit board to be electrically connected by an external transmission line to an external setting apparatus; and
a flexible shell having a surface area greater than said circuit board, said flexible shell comprising an uplifted area on the middle, an opening, a switch accommodation hole for accommodating said power switch and a connection port accommodation hole for accommodating said connection port.

2. The programmable tire-condition sensor as claimed in claim 1, wherein the elevation difference between the lowest surface of said uplifted area and the lowest surface of the periphery of said flexible shell is smaller than the height of said control module.

3. The programmable tire-condition sensor as claimed in claim 2, wherein said flexible shell further comprises two annular inside flanges protruded from a bottom wall thereof and respectively extending around said switch accommodation hole and said connection port accommodation hole for sleeving onto said power switch and said connection port respectively.

4. The programmable tire-condition sensor as claimed in claim 3, wherein said circuit board comprises two mounting notches respectively disposed at two distal ends thereof for attaching to two protruding blocks of the vehicle tire respectively upon installation of said control module in the vehicle tire to enhance installation stability.

5. The programmable tire-condition sensor as claimed in claim 4, wherein the distance between the two protruding blocks of the vehicle tire is not greater than the distance between said two mounting notches of said circuit board.

6. The programmable tire-condition sensor as claimed in claim 2, wherein said circuit board comprises two mounting notches respectively disposed at two distal ends thereof for attaching to two protruding blocks of the vehicle tire respectively upon installation of said control module in the vehicle tire to enhance installation stability.

7. The programmable tire-condition sensor as claimed in claim 6, wherein the distance between the two protruding blocks of the vehicle tire is not greater than the distance between said two mounting notches of said circuit board.

8. The programmable tire-condition sensor as claimed in claim 1, wherein said flexible shell further comprises two annular inside flanges protruded from a bottom wall thereof and respectively extending around said switch accommodation hole and said connection port accommodation hole for sleeving onto said power switch and said connection port respectively.

9. The programmable tire-condition sensor as claimed in claim 8, wherein said circuit board comprises two mounting notches respectively disposed at two distal ends thereof for attaching to two protruding blocks of the vehicle tire respectively upon installation of said control module in the vehicle tire to enhance installation stability.

10. The programmable tire-condition sensor as claimed in claim 9, wherein the distance between the two protruding blocks of the vehicle tire is not greater than the distance between said two mounting notches of said circuit board.

11. The programmable tire-condition sensor as claimed in claim 1, wherein said circuit board comprises two mounting notches respectively disposed at two distal ends thereof for attaching to two protruding blocks of the vehicle tire respectively upon installation of said control module in the vehicle tire to enhance installation stability.

12. The programmable tire-condition sensor as claimed in claim 11, wherein the distance between the two protruding blocks of the vehicle tire is not greater than the distance between said two mounting notches of said circuit board.

13. The programmable tire-condition sensor as claimed in claim 1, wherein said flexible shell is made of natural rubber or synthetic rubber.

14. The programmable tire-condition sensor as claimed in claim 1, wherein said transmission interface means comprises a low frequency transmission interface and a radio frequency transmission interface adapted for transmitting the data sensed by said pressure sensor, said temperature sensor and said acceleration sensor to the vehicle receiving device.

15. A vehicle tire having installed therein a programmable tire-condition sensor as claimed in claim 1, wherein said programmable tire-condition sensor is installed in an inner side of the bead filler of the vehicle tire.

16. A method for installing a programmable tire-condition sensor as claimed in claim 1 in a vehicle tire, the method comprising a first step of covering said flexible shell onto said control module, a second step of applying an adhesive to the periphery of said flexible shell, and a third step of bonding said flexible shell to the vehicle tire by thermo-compression bonding to hold said control module in between said flexible shell and the vehicle tire.
